(19) United States
(12) Patent Application Publication
(10) Pub. No.: US 2010/0231869 A1
(43) Pub. Date: Sep. 16, 2010

(54) Illuminating system and brightness control apparatus thereof

(75) Inventors: Chuan-Te Cheng, Hsinchu (TW); Hui-Chen Lin, Hsin-Chu (TW)

Correspondence Address: BACON & THOMAS, PLLC, 625 SLATERS LANE, FOURTH FLOOR, ALEXANDRIA, VA, 22314-1176, US

(73) Assignee: Coretronic Corporation, Hsin-Chu (TW)

(21) Appl. No.: 12/659,502

(22) Filed: Mar. 11, 2010

(30) Foreign Application Priority Data
Mar. 16, 2009 (TW) 098204045

(51) Int. Cl. G03B 21/14; F21V 17/02

(52) U.S. Cl. 353/84; 362/322; 353/97

(57) ABSTRACT

A brightness control apparatus applied to an illuminating system of a projector includes a plate and a slot portion. The slot portion is formed in the plate for a light beam of the illuminating system passing through. The slot portion has two opposite edges located at two sides of an arc locus. The center of the arc locus is a rotating center of the plate. The distance between the two edges of the slot portion is changed with the arc locus. The arc locus has a start point and an arbitrary point which are relative to the center of the arc locus, so as to form a central angle. The mathematics relationship between the distance of the two edges at the arbitrary point and the central angle is a polynomial function. The degree of the term with the highest degree is equal to or more than six.

### BACKGROUND OF THE INVENTION

(1) Field of the Invention

The invention relates to an illuminating system and brightness control apparatus thereof, and especially relates to an illuminating system and a brightness control apparatus using dynamic aperture mask.

(2) Description of the Prior Art

FIG. 1 is a schematic view of an illuminating system of a conventional projector. The illuminating system 100 has a light source 120, a dynamic aperture mask 160, a color wheel 140, and a integration rod 180. The dynamic aperture mask 160, the color wheel 140, and the integration rod 180 are sequentially disposed on the light path of the light beam generated by the light source 120. The dynamic aperture mask 160 is driven to rotate by a stepper motor 170 for controlling the light energy passing through the color wheel 140 and the integration rod 180, which is to control the brightness of the illuminating system 100.

Referring to FIG. 2, the dynamic aperture mask 160 has a disc 161 and a slot 162 formed in the disc 161. The rotating center of the disc 161 is connected to an axle 172 of the stepper motor 170 for rotating the disc 161 as arrow ‘a’ shows. The slot 162 penetrates through the disc 161 for the light beam passing through the disc 161 to enter the color wheel 140 and the integration rod 180.

Referring to FIG. 2 and FIG. 3A, the width ‘w’ of the slot 162 satisfies a linear equation L: y=Ax+B, where y is half of the width ‘w’, x is a rotation angle, intercept is half of the narrowest width of the slot 162, and slope A is defined as a variation in half of the width ‘w’ of the slot 162 varying with the rotation angle x of the disc 161. For example, if widths of two arbitrary positions p1 and p2 are w1 and w2, then the difference between the two widths is Δy=w2−w1 and the rotation angle Δx, between p1 and p2, is a central angle that the arc between p1 and p2 relates to the axle 172, where the slope A=(Δy/Δx)/2.

However, if the slot 162 of the conventional dynamic aperture mask 160 is applied to the illuminating system of a projector, then the brightness curve of the projector is excessively changed. Referring to FIG. 3B, the vertical axis is light energy or the brightness of the projector, and the horizontal axis is central angle, and the central angle corresponding to the narrowest end of the slot 162 is defined as zero degree. As the figure shows, the brightness decreases from 65% to 25% upon 10 degrees variation between zero degree and 10 degrees, and is changed slowly between 10 degrees and 260 degrees. Accordingly, the light energy passing through the slot 162 does not vary smoothly during the process of rotating the dynamic aperture mask 160 and the brightness of the illuminating system 100 may not be controlled stably. Such kind of dynamic aperture mask 160 may not be cooperated with DynamicBlack™ technique of Texas Instruments Incorporated.

### SUMMARY OF THE INVENTION

Accordingly, the object of the invention is to provide a brightness control apparatus which is applied to an illuminating system for stably controlling the brightness provided by the illuminating system.

To achieve one of, a part of or all of the above-mentioned advantages, an embodiment of the present invention provides a brightness control apparatus applied to an illuminating system. The brightness control apparatus includes a plate and a slot portion. The plate has a rotating center. The slot portion is formed in the plate for a light beam of the illuminating system passing through. The slot portion has two opposite edges located at two sides of an arc locus. The center of the arc locus is the rotating center of the plate. The distance between the two edges is changed with the arc locus. The arc locus has a start point and an arbitrary point to form a central angle relative to the center of the arc locus. The mathematics relationship between the distance of the two edges at the arbitrary point and the central angle is a polynomial function having a term with the highest degree equal to or more than six.

In an embodiment, the plate is a disc. The polynomial function has a plurality of terms. When the terms are ranked in ascending or descending order, coefficients of all the terms with one or one plus degrees in the polynomial function are arranged positive and negative alternately, and the absolute values of the coefficients of all the terms with one or one plus degrees decrease with increase of the degree of the terms. For example, the polynomial function is y=−1×10⁻¹²x⁶+8×10⁻¹⁰x⁵−2×10⁻⁷x⁴+2×10⁻⁵x³−0.0012x²+0.0257x+0.5746, where y is half of the distance between the two edges at the arbitrary point, and x is the central angle.

The slot portion has a minimum distance and a maximum distance between the two edges, and the maximum distance is 8 times longer than the minimum distance. In an embodiment, the central angle relative to the minimum distance between the two edges of the slot portion is zero degree, and the central angle relative to the maximum distance is 270 degrees.

An embodiment of the present invention provides a n illuminating system of a projector including a light source, an integration rod, the abovementioned brightness control apparatus, and a color wheel. The light source is capable of providing a light beam. The integration rod is disposed in a light path of the light beam. The slot portion of the brightness control apparatus is disposed on the light path. The color wheel is between the light source and the integration rod and disposed in the light path. The brightness control apparatus is disposed between the light source and the color wheel or between the color wheel and the integration rod.

The embodiment or the embodiments of the invention may have at least one of the following advantages. Because the distance between the two edges of the slot portion and the center angle satisfies the polynomial function r, and the distance is changed with the arc locus, the slot portion allows different light energy passing through at different times. Thus, the brightness of the image projected by the projector may be controlled stably.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a schematic view of an illuminating system of a conventional projector.

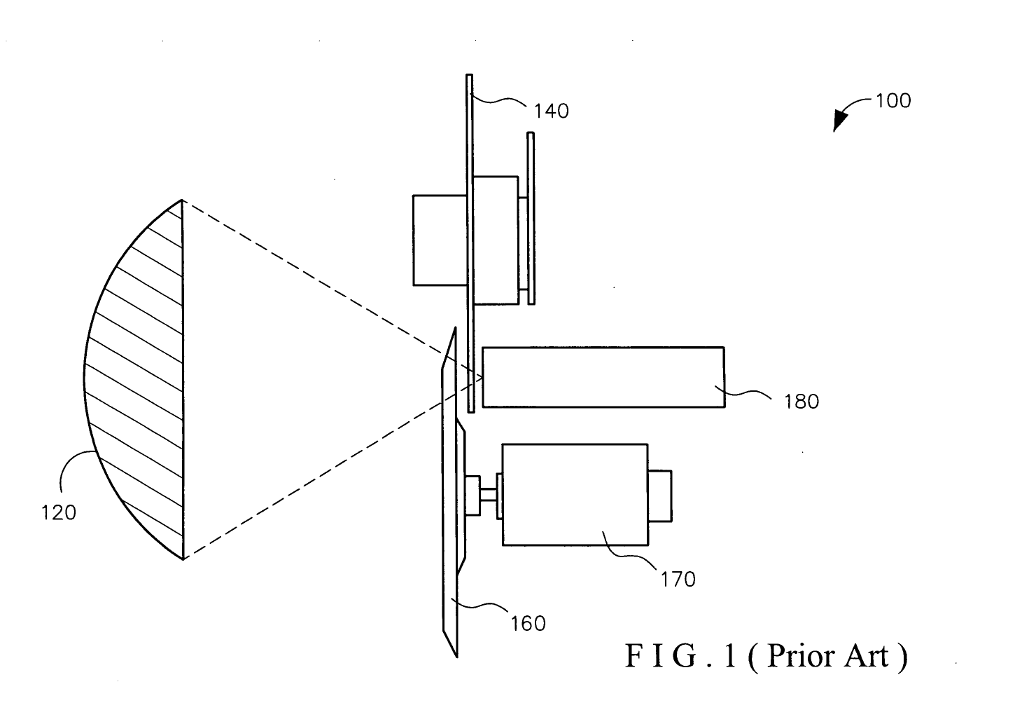

FIG. 2 is a schematic view of a conventional dynamic aperture mask.

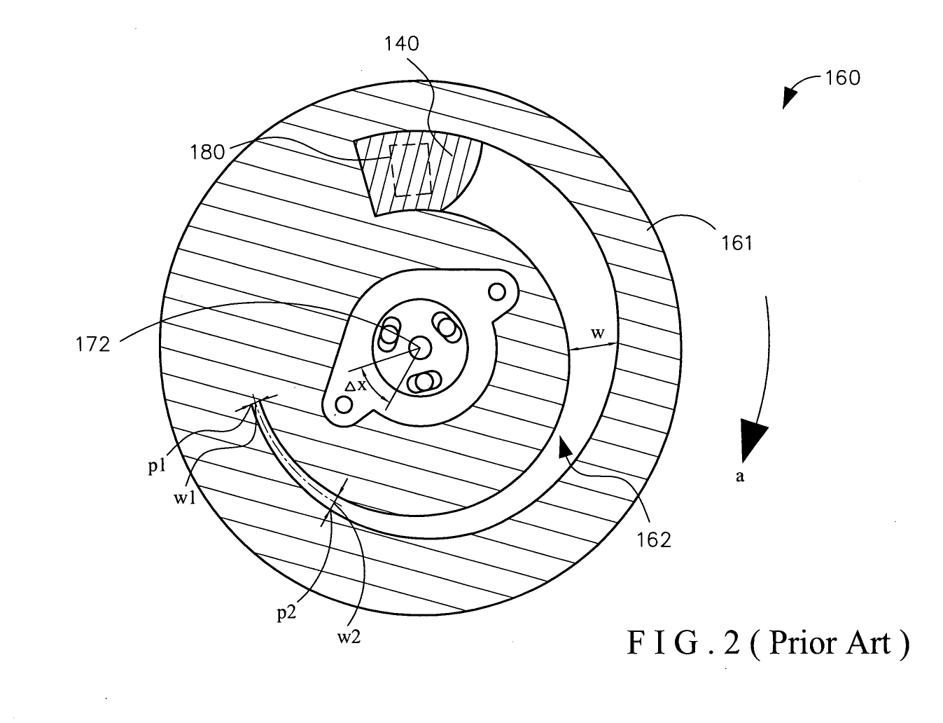

FIG. 3A is a relation diagram of slot width and central angle of a conventional dynamic aperture mask.

FIG. 3B is a relation diagram of light energy and central angle.

FIG. 4A is a schematic view of a brightness control apparatus according to an embodiment of the present invention.

FIG. 4B is a relation diagram of central angle and distance between two edges of a slot according to an embodiment of the present invention.

FIG. 5 is a schematic view of an illuminating system according to an embodiment of the present invention.

FIG. 6 is a relation diagram of light energy and central angle according to an embodiment of the present invention.

FIG. 7 is a schematic view of an projector according to an embodiment of the present invention.

### DESCRIPTION OF THE PREFERRED EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the present invention may be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected;” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

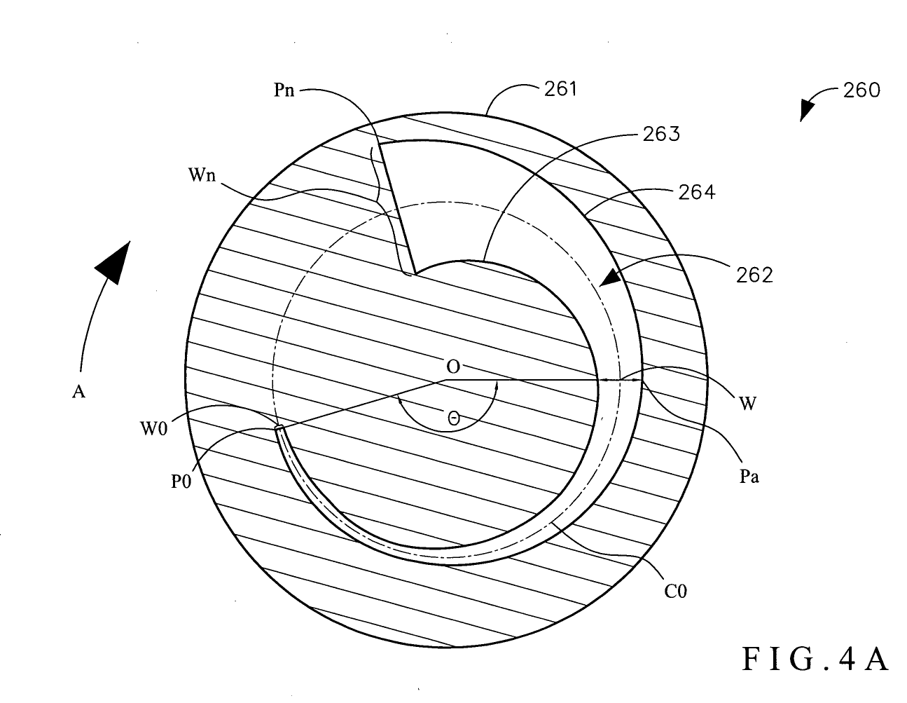

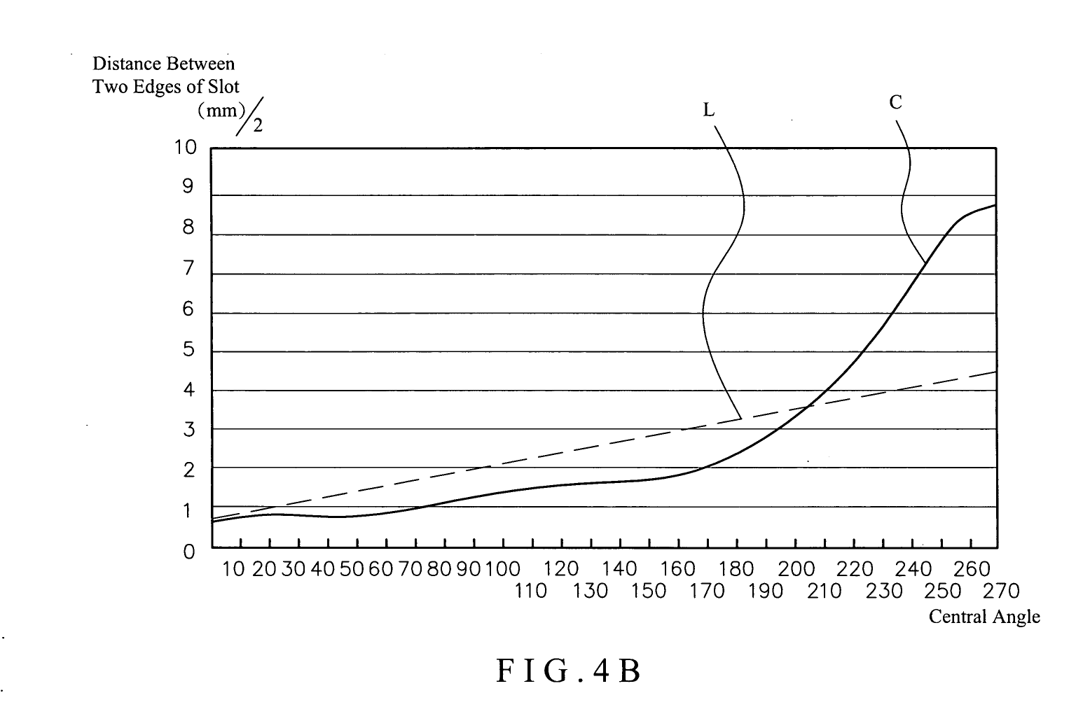

Refer to FIG. 4A for a brightness control apparatus 260 for controlling the brightness of the illuminating system. The brightness control apparatus 260 includes a plate 261 and a slot portion 262. The plate 261, for example, a disc, rotates around a rotating center O as arrow A. The slot portion 262 is formed in the plate 261 for a light beam of the illuminating system passing through.

The slot portion 262 has two opposite edges 263 and 264 located at two sides of an arc locus C0 separately and extends along the arc locus C0.

The center of the arc locus C0 is the rotating center O of the plate 261. The distance W between the two edges 263, 264 is changed along the arc locus C0. The arc locus C0 has a start point P0 and an arbitrary point Pa for defining an arc length which is relative to the rotating center O, so as to form a central angle θ. At the arbitrary point Pa, the mathematics relationship between the distance W of the two edges 263, 264 and the central angle θ is a polynomial function.

Referring to FIG. 4B, in the present embodiment, the polynomial function is y=−1×10⁻¹²x⁶+8×10⁻¹⁰x⁵−2×10⁻⁷x⁴+2×10⁻⁵x³−0.0012x²+0.0257x+0.5746, where y is half of a distance (W/2) between the two edges 263, 264, and x is the central angle θ, as curve C shows. The horizontal axis in FIG. 4B is the central angle θ related to different points P0, . . . Pa, . . . , Pn on the arc locus C0 of FIG. 4A. For example, zero degree means that the arbitrary point Pa is the start point P0, and 270 degrees means that the arbitrary point Pa is the end point Pn. The horizontal axis is half of distances W0, . . . W, . . . Wn between the two edges 263, 264 at different points P0, . . . Pa, . . . , Pn. The central angle θ related to the constant of the polynomial function is zero degree. The central angle that the constant term of the polynomial function corresponds to is 10 degrees and it represents the distance W0 between the two edges 263 and 264 of the slot portion 262, which is the smallest distance. What is remarkable is that in the embodiment, the central angle of 270 degrees means the arbitrary point Pa could be the end point Pn, but does not limit the scope of the present invention.

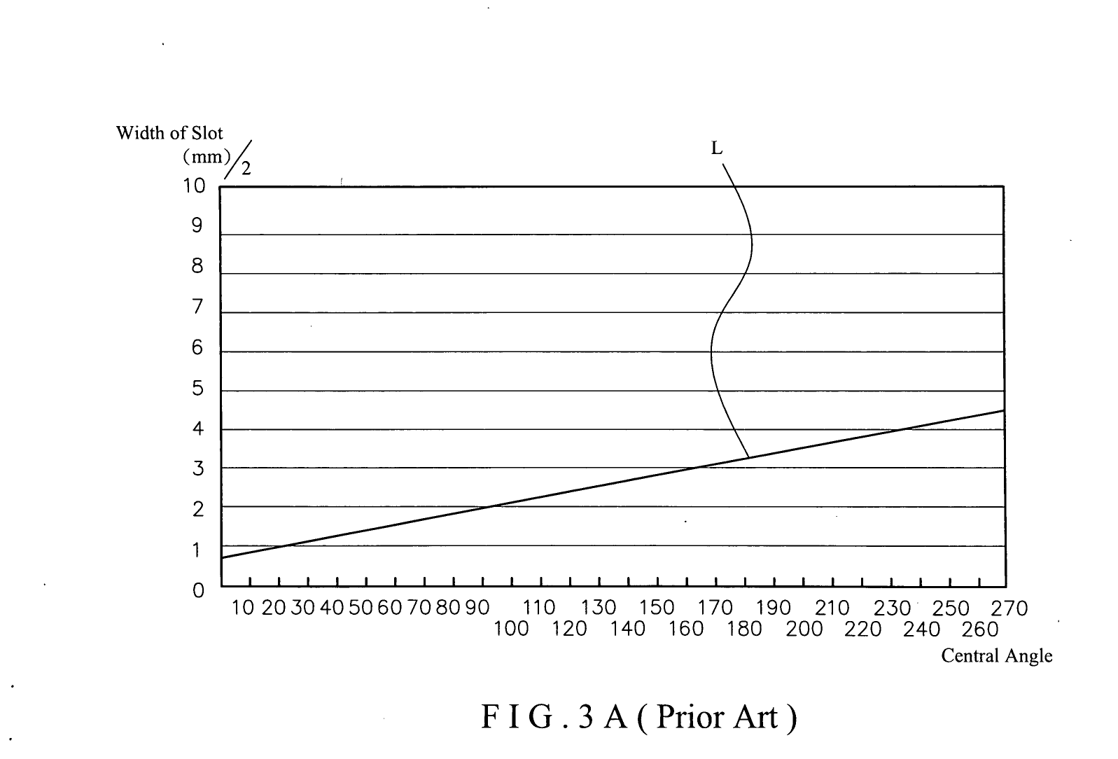

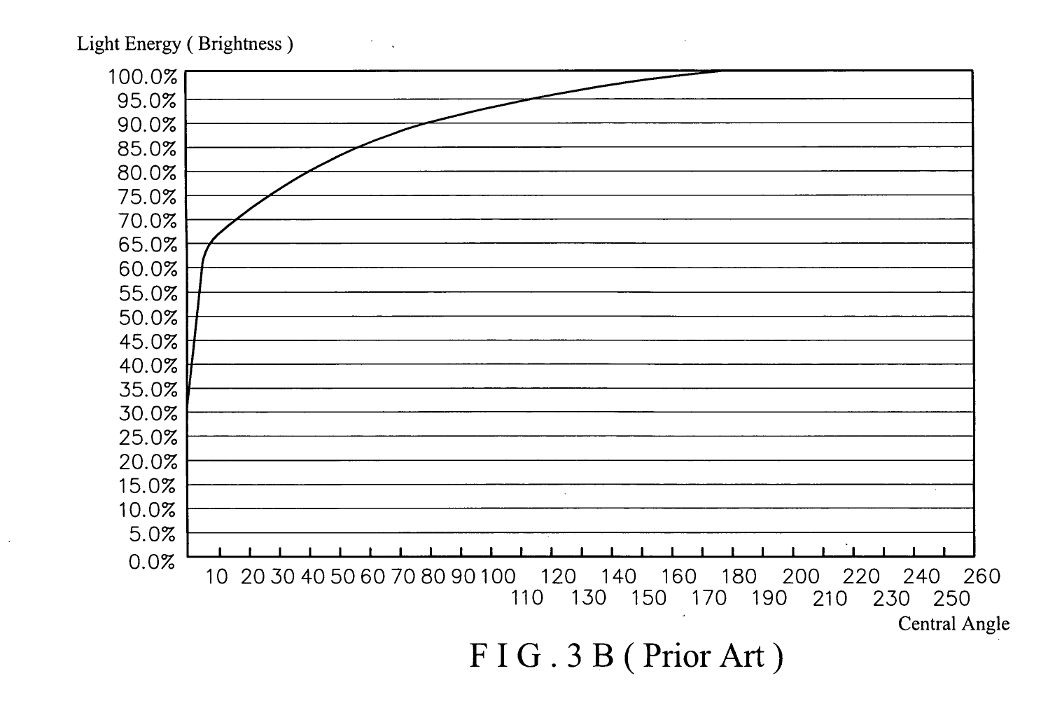

In the conventional technology of FIG. 3A, the width ‘w’ of the slot 162 is changed with the central angle Δx as line L shows. However, in the present embodiment, the distance W between the two edges 263 and 264 of the slot portion 262 is changed as the curve C shown in FIG. 4B. When the central angle θ is between zero degree and 180 degrees, the distance W increases less than the line L does. When the central angle θ is between 180 degrees and 270 degrees, the distance W increases more than the line L does. What is remarkable is that in the present embodiment, when the central angle θ is 270 degrees, the slot portion 262 has the maximum distance Wn between the two edges 263 and 264. The maximum distance Wn is 8 times larger than the minimum distance W0. However, it is an embodiment of the present invention, but not limit to it.

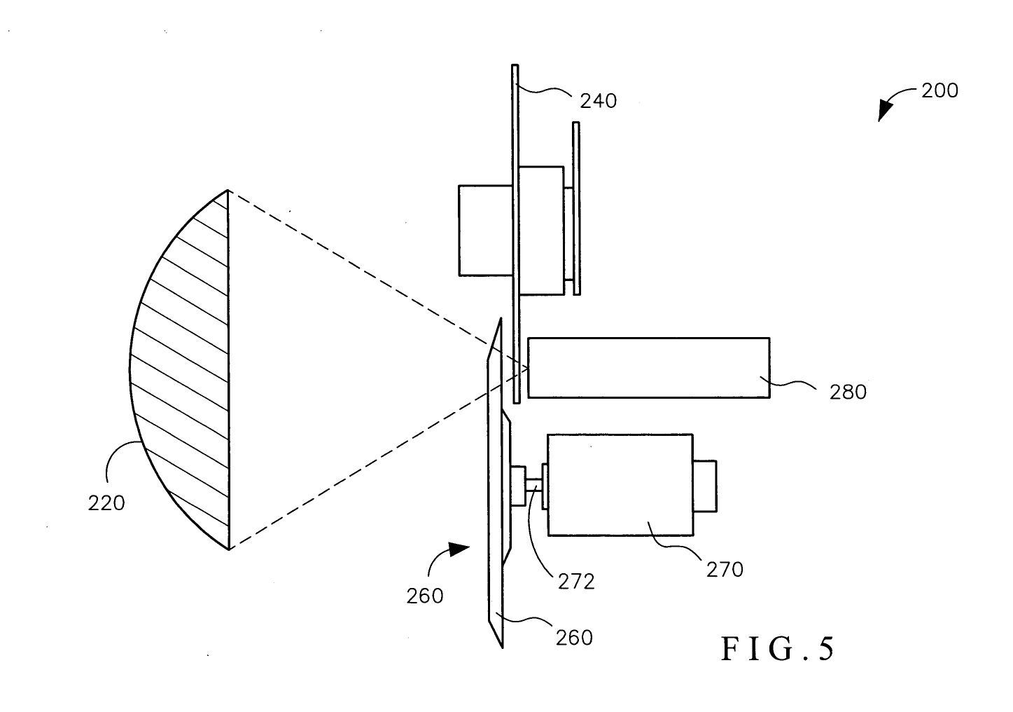

Refer to FIG. 5 for an embodiment of the brightness control apparatus 260 adopted in an illuminating system 200. The illuminating system 200 includes a light source 220, a integration rod 280, the above-mentioned brightness control apparatus 260, and a color wheel 240. The light source 220 provides a light beam. The integration rod 280 is disposed in the light path of the light beam. The brightness control apparatus 260 is disposed between the integration rod 280 and the light source 220, and the slot portion (not shown in this figure) is disposed in the light path. The color wheel 240 is disposed between the light source 220 and the integration rod 280 in the light path.

Referring to FIG. 4A and FIG. 5, the brightness control apparatus 260 uses a driving device such as a stepper motor 270 to make the plate 261 and the slot portion 262 rotate around the rotating center O. As FIG. 4A and FIG. 5 show, the stepper motor 270 has a rotating axle 272 connected to the rotating center O of the plate 261. The different points P0, . . . Pa, . . . , Pn of the arc locus C0 are rotated to the light path at different time. At different points P0, . . . Pa, . . . , Pn, there are different distances W0, . . . W, . . . , Wn between the two edges 263 and 264. Thus, different light energy is allowed to pass at different time. For example, the maximum distance Wn allows the largest light energy to pass through, so as to control the brightness.

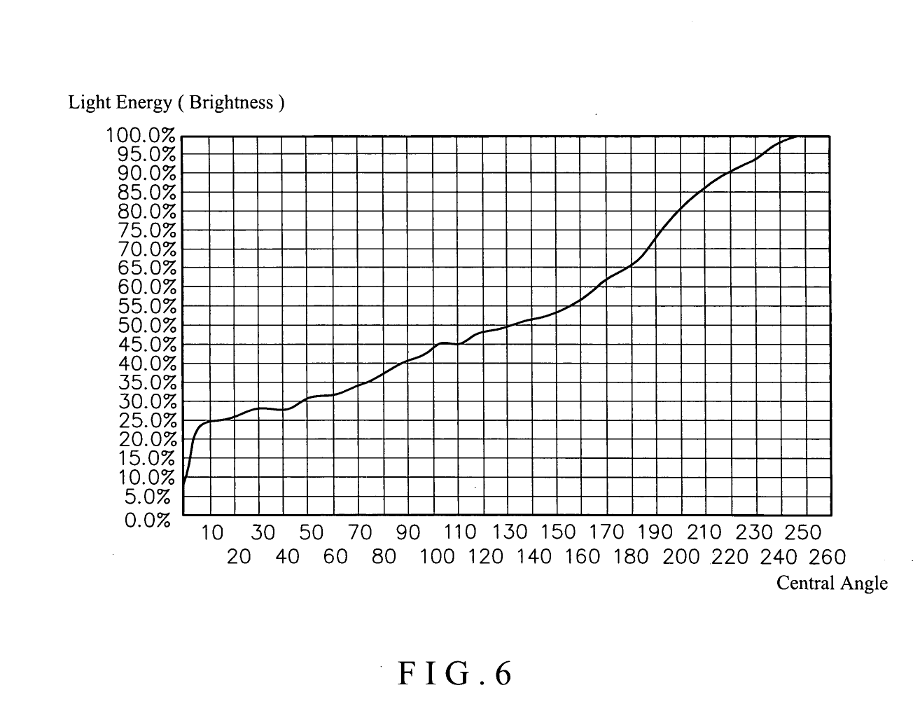

Refer to FIG. 6 for a light energy change curve of the slot portion 262 at different central angle θ during the rotation of the brightness control apparatus 260. The largest light energy is provided to the integration rod 280 at the maximum distance Wn between the two edges 263 and 264 of the slot portion 262. The light energy at the minimum distance W0 is 25%-0% of at the maximum distance Wn. Moreover, the brightness control apparatus 260 provides proper brightness to different images projected by a projector, so that the image has a good contrast.

Comparing to the conventional dynamic aperture mask 160, in the present embodiment, when the plate 261 of the brightness control apparatus 260 rotates 10 degrees (central angle), the light energy passing through the slot portion 262 is 25% of the maximum distance Wn, which means the brightness of the corresponding dark image decreases to one-fourth original brightness and the contrast increases to 4 times.

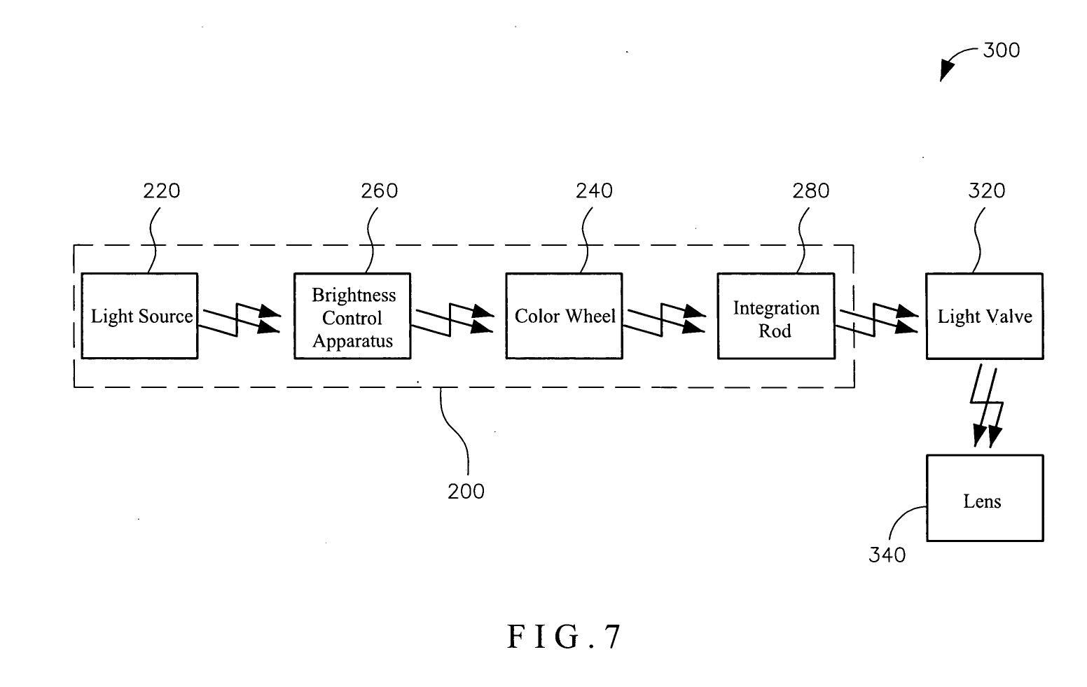

Refer to FIG. 7 for an embodiment of an projector 300 adopting the brightness control apparatus 260. The projector 300 includes the illuminating system 200, a light valve 320 and a lens 340. The brightness of the light beam provided by the illuminating system 200 is controlled by the brightness control apparatus 260. The light valve 320 may be a digital micromirror device (DMD), a transparent liquid crystal display (LCD) or a liquid crystal on silicon (LCOS), disposed on the light path to make the light beams to form an image. The image is projected through the lens 340.

In an embodiment, the brightness control apparatus 260 may be disposed between the light source 220 and the color wheel 240, between the color wheel 240 and the integration rod 280, between the integration rod 280 and the light valve 320 or between the light valve 320 and the lens 340.

The embodiment or the embodiments of the invention may have at least one of the following advantages. In above embodiment or other embodiments of the present invention, the degree of the term with the highest degree in the polynomial function is equal to or more than six. When the terms of the polynomial function except the constant, the terms with one or one plus degree, are ranked in ascending or descending order, the coefficients of the terms are arranged positive and negative alternately, and their absolute values decrease with increase of the degree of the term, which forms a smooth curve between the two edges 263 and 264 of the slot portion 262. According to the polynomial function, the distance between the two edges 263 and 264 of the slot portion 262 may be designed to stably control the brightness and increase the contrast of the image. The brightness control apparatus 260 of the present embodiment may be cooperated with DynamicBlack™ technique of Texas Instruments Incorporated for controlling the action of the brightness control apparatus 260 as well as the move of the plate 261.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A brightness control apparatus, applied to an illuminating system, the brightness control apparatus comprising:
a plate, having a rotating center; and
a slot portion, formed in the plate for a light beam of the illuminating system passing through, the slot portion having two opposite edges located at two sides of an arc locus, wherein the center of the arc locus is the rotating center of the plate and the distance between the two edges is changed along the arc locus, the arc locus having a start point and an arbitrary point to form a central angle relative to the center of the arc locus, wherein the mathematics relationship between the distance of the two edges at the arbitrary point and the central angle is a polynomial function having a term with the highest degree equal to or more than six.

2. The brightness control apparatus of claim 1, wherein the polynomial function has a plurality of terms, coefficients of all the terms with one or one plus degrees in the polynomial function are arranged positive and negative alternately when the terms are ranked in ascending or descending order.

3. The brightness control apparatus of claim 1, wherein the polynomial function has a plurality of terms, the absolute values of the coefficient of all the terms with one or one plus degrees decrease with increase of the degree of the terms.

4. The brightness control apparatus of claim 1, wherein the polynomial function is y=−1×10⁻¹²x⁶+8×10⁻¹⁰ x⁵−2×10⁻⁷x⁴+2×10⁻⁵x³−0.0012x²+0.0257x+0.5746, where y is half of the distance between the two edges at the arbitrary point, and x is the central angle.

5. The brightness control apparatus of claim 1, wherein the slot portion has a minimum distance and a maximum distance between the two edges, and the maximum distance is 8 times longer than the minimum distance.

6. The brightness control apparatus of claim 5, wherein the central angle relative to the minimum distance between the two edges of the slot portion is zero degree, and the central angle relative to the maximum distance is 270 degrees.

7. The brightness control apparatus of claim 1, wherein the plate is a disc.

8. The brightness control apparatus of claim 1, further comprising a stepper motor, wherein the stepper motor has a rotating axis connected to the rotating center of the plate.

9. An illuminating system of a projector, comprising:
a light source, capable of providing a light beam;
an integration rod, disposed in a light path of the light beam;
a brightness control apparatus, comprising a plate with a rotating center and a slot portion formed in the plate and disposed in the light path, the slot portion having two opposite edges located on two sides of an arc locus, wherein the center of the arc locus is the rotating center of the plate and the distance between the two edges is changed along the arc locus, the arc locus having a start point and an arbitrary point formed a central angle relative to the center, wherein the mathematics relationship between the distance of the two edges at the arbitrary point and the central angle is a polynomial function having a term with the highest degree equal to or more than six; and
a color wheel, disposed in the light path.

10. The illuminating system of claim 9, wherein the color wheel is disposed between the light source and the integration rod, and the brightness control apparatus is disposed between the light source and the color wheel.

11. The illuminating system of claim 9, wherein the brightness control apparatus is disposed between the color wheel and the integration rod.

12. The illuminating system of claim 9, wherein the polynomial function has a plurality of terms, all the terms with one or one plus degrees in the polynomial function are arranged positive and negative alternately when the terms are ranked in ascending or descending order.

13. The illuminating system of claim 9, wherein the polynomial function has a plurality of terms, the absolute values of the coefficients of all the terms with one or one plus degrees decrease with increase of the degree of the terms.

14. The illuminating system of claim 9, the polynomial function is y=−1×10⁻¹²x⁶+8×10⁻¹⁰x⁵−2×10⁻⁷x⁴+2×10⁻⁵x³−0.0012x²+0.0257x+0.5746, where y is half of the distance between the two edges at the arbitrary point, and x is the central angle.

15. The illuminating system of claim 9, wherein the slot portion has a minimum distance and a maximum distance between the two edges, and the maximum distance is 8 times longer than the minimum distance.

16. The illuminating system of claim 15, wherein the central angle relative to the minimum distance between the two edges of the slot portion is zero degree, and the central angle relative to the maximum distance is 270 degrees.

17. The illuminating system of claim 9, wherein the plate of the brightness control apparatus is a disc.

18. The illuminating system of claim 9, wherein the brightness control apparatus comprises a stepper motor having a rotating axis connected to the rotating center of the plate.
